(19) United States
(12) Patent Application Publication
(10) Pub. No.: US 2010/0112446 A1
(43) Pub. Date: May 6, 2010

(54) ACTIVE ELECTRODE MATERIAL, MANUFACTURING METHOD OF SAME, AND LITHIUM-ION BATTERY USING THAT ACTIVE ELECTRODE MATERIAL

(75) Inventors: Shigeto Okada, Fukuoka (JP); Jun-Ichi Yamaki, Fukuoka (JP); Motoshi Isono, Aichi-ken (JP)

Correspondence Address: GIFFORD, KRASS, SPRINKLE,ANDERSON & CITKOWSKI, P.C, PO BOX 7021, TROY, MI, 48007-7021, US

(73) Assignee: Kyushu University, National University Corporation, Fukuoka-Shi (JP)

(21) Appl. No.: 12/528,895

(22) PCT Filed: Apr. 8, 2009
(86) PCT No.: PCT/IB2008/001522

§ 371 Date: Aug. 27, 2009

(30) Foreign Application Priority Data
Apr. 13, 2007 (JP) 2007-105574

(51) Int. Cl. H01M 4/131; H01M 4/04

(52) U.S. Cl. 429/221; 252/182.1

(57) ABSTRACT

Electrode active material is provided which is mainly an amorphous iron-phosphate complex represented by LiₓFeP_{y}O_{z}, where x and y are values which independently satisfy 2<x≦2.5 and 1.5≦y≦2, respectively, z=(x+5y+valence of iron)/2 to satisfy stoichiometry, and the valence of iron is 2 or 3.

### BACKGROUND OF THE INVENTION

1. Field of the Invention

The invention relates to high capacity electrode active material which is mainly an amorphous iron-phosphate complex represented by LiₓFeP_{y}O_{z}, a manufacturing method of that electrode active material, and a lithium-ion battery to which that active electrode material has been applied.

2. Description of the Related Art

A secondary battery is known which charges and discharges by cations such as lithium ions traveling between electrodes. One classic example of such a secondary battery is a lithium-ion secondary battery. Material that can absorb and release lithium ions can be used for the electrode active material of such a secondary battery. One example of such material is carbonaceous material such as graphite which is an example of negative electrode active material. On the other hand, an example of positive electrode active material is an oxide which has lithium and a transition metal as constituent elements, such as lithium nickel oxide or lithium cobalt oxide (hereinafter, such an oxide may also be referred to as a “lithium-containing composite oxide”). Moreover, in recent years, chemical compounds having an olivine structure, e.g., chemical compounds represented by the general expression LiMPO₄ (M=Mn, Fe, Co, Cu, V), are promising for positive electrode active material due in part to their large theoretical capacity.

Meanwhile, Japanese Patent Application Publication No. 2005-158673 (JP-A-2005-158673) describes electrode active material which is mainly an amorphous metal-phosphate complex that has an olivine structure. With the electrode active material that is mainly a metal-phosphate complex, an amorphous body can be synthesized from an inexpensive metal oxide at an extremely low cost and in a short period of time by rapid cooling compared with a crystalline body of related art. What is more, the resultant amorphous body seems to display the same battery properties as a crystalline body.

However, with electrode active material that is mainly an amorphous metal-phosphate complex represented by LiₓFeP_{y}O_{z}, the optimal range of the relative proportions of x, y, and z that would increase the capacity is not known so the capacity is small.

### SUMMARY OF THE INVENTION

This invention thus provides high capacity electrode active material that is mainly an amorphous iron-phosphate complex represented by LiₓFeP_{y}O_{z}.

A first aspect of the invention relates to electrode active material which is represented by LiₓFeP_{y}O_{z} (where x and y are values which independently satisfy 2<x≦2.5 and 1.5≦y≦2, respectively, z=(x+5y+valence of iron)/2 to satisfy stoichiometry, and the valence of the iron is 2 or 3) and has an amorphous iron-phosphate complex as a main constituent.

According to this first aspect of the invention, having the relative proportions of the electrode ‘active material which is mainly an amorphous’ iron-phosphate complex represented by LiₓFeP_{y}O_{z} be 2<x≦2.5, 1.5≦y≦2, and z=(x+5y+valence 2 or 3 of iron)/2 enables the electrons and lithium ions to move easily which is necessary to achieve high capacity, thereby enabling high capacity electrode active material to be obtained.

A second aspect of the invention relates to a manufacturing method for electrode active material, which includes melt mixing raw material composition that includes raw materials that make up LiₓFeP_{y}O_{z} (where x and y are values which independently satisfy 2<x≦2.5 and 1.5≦y≦2, respectively, z=(x+5y+valence of iron)/2 to satisfy stoichiometry, and the valence of iron is 2 or 3); and rapidly solidifying from a molten state the raw material composition that was melt mixed.

According to this second aspect of the invention, having the relative proportions of the electrode active material which is mainly an amorphous iron-phosphate complex represented by LiₓFeP_{y}O_{z} be 2<x≦2.5, 1.5≦y≦2, and z=(x+5y+valence 2 or 3 of iron)/2 enables the electrons and lithium ions to move easily which is necessary to achieve high capacity, thereby enabling high capacity electrode active material to be obtained.

A third aspect of the invention relates to a lithium-ion secondary battery that includes a positive electrode layer that includes the electrode active material according to the first aspect of the invention as positive electrode active material, a negative electrode layer that includes negative electrode active material, and a nonaqueous electrolyte.

According to this third aspect of the invention, a high capacity lithium-ion secondary battery can be obtained.

This invention enables electrode active material that is mainly an amorphous iron-phosphate complex represented by LiₓFeP_{y}O_{z} and which has a high capacity to be obtained.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a graph showing the specific capacitances (mAh/g) of nonaqueous electrolyte secondary batteries using the electrode active material obtained from Examples 1 and 2 and Comparative examples 1 and 2 with respect to Li/Fe (molar ratio); and

FIG. 2 is a graph showing the specific capacitances (mAh/g) of nonaqueous electrolyte secondary batteries using the electrode active material obtained from Examples 3 and 4 and Comparative examples 3 and 4 with respect to P/Fe (molar ratio).

### DETAILED DESCRIPTION OF THE EMBODIMENTS

First, the electrode active material according to an example embodiment of the invention will be described. The electrode active material according to the example embodiment of the invention is mainly an amorphous iron-phosphate complex represented by LiₓFeP_{y}O_{z} (where x and y are values which independently satisfy 2<x≦2.5 and 1.5≦y≦2, respectively, and z=(x+5y+valence of iron)/2 to satisfy stoichiometry, and the valance of iron is 2 or 3).

According to this example embodiment of the invention, having the relative proportions of the electrode active material which is mainly an amorphous iron-phosphate complex represented by LiₓFeP_{y}O_{z} be 2<x≦2.5, 1.5≦y≦≦2, and z=(x +5y+valence 2 or 3 of iron)/2 enables the electrons and lithium ions to move easily which is necessary to achieve high capacity, thereby enabling high capacity electrode active material to be obtained. Hereinafter the electrode active material of the example embodiment of the invention will be described in more detail.

The iron-phosphate complex in this example embodiment of the invention is represented by the following General expression (1).

LiₓFeP_{y}O₂ (1)

where x and y are values which independently satisfy 2<x≦2.5 and 1.5≦y≦2, respectively, and z=(x+5y+valence of iron)/2 to satisfy stoichiometry, and the valance of iron is 2 or 3.
In this expression, if x and y are values within the composition range described above, electrode active material that is mainly an amorphous iron-phosphate complex represented by LiₓFeP_{y}O_{z} and which has a high capacity can be obtained. The reason for this is thought to be as follows. In order to improve the capacity in the electrode active material, it is necessary that not only Li be easily dispersed, but also that electrons be able to move easily. That is, in this electrode active material, when x(=Li/Fe (molar ratio)) that represents the ratio of Li is within the range described above, the amount of Li with respect to Fe increases so Li disperses easier. Also, P (phosphorous) may interfere with the movement of electrons so by keeping y(=P/Fe (molar ratio)) which represents the ratio of P within the range described above, the amount of P with respect to Fe becomes less. As a result, the interference of the movement of electrons caused by P is suppressed so the electrons can move easier. As described above, x and y in this example embodiment of the invention do satisfy the composition range described above. However, it is preferable that they be within the ranges of 2.25≦x≦2.5 and 1.5≦y≦1.75, respectively.

Also, in General expression LiₓFeP_{y}O_{z} (1), the value of z is a value that is determined by the valence of iron and the values of x and y to satisfy stoichiometry, and is expressed by the following Equation (2).

z=(x+5y+valence 2 or 3 of iron)/2 (2)

In Equation (2), the valence of iron is 2 when the iron-phosphate complex is reacted in an inert atmosphere or a reducing atmosphere (simply referred to as a “non-oxidizing environment” in this specification), and is 3 when it is reacted in an oxidizing atmosphere. Therefore, the iron takes on either a valence of 2 or 3 depending on the atmosphere. In this case, z can more specifically be a value that is within the composition range of 5.75≦z≦7.75. In this invention, the atmosphere is preferably a non-oxidizing atmosphere, i.e., the valence of iron is preferably 2. In this case, z is a value within the composition range of 5.75≦z≦7.25.

In this example embodiment of this invention, the iron-phosphate complex with the composition of the foregoing General expression (1) LiₓFeP_{y}O_{z} (where x and y are values which independently satisfy 2<x≦2.5 and 1.5≦y≦2, respectively, and z=(x+5y+valence of iron)/2 to satisfy stoichiometry, and the valance of iron is 2 or 3) is an amorphous material. The amorphous iron-phosphate complex may be amorphous to the extent that one or two or more of the following conditions are satisfied, for example. (1) the average crystallite size is equal to or less than approximately 1000 Angstrom (preferably equal to or less than approximately 100 Angstrom, and more preferably equal to or less than 50 Angstrom); (2) the specific gravity of the iron-phosphate complex is large at equal to or greater than approximately 3% (and more preferably equal to or greater than approximately 5%) compared to the specific gravity (theoretical value) when the iron-phosphate complex is completely crystalline; and (3) no peak which supports the iron-phosphate complex being crystalline can be observed in an X-ray diffraction pattern. That is, a classic example of the iron-phosphate complex described here is mainly a lithium iron-phosphate complex that satisfies one or two or more of the foregoing conditions (1) to (3). In the invention, the iron-phosphate complex is preferably a lithium iron-phosphate complex that satisfies at least condition (3). Incidentally, the X-ray pattern can be obtained using an X-ray diffractometer (XRD) (model number Rigaku RINT 2100 HLR/PC) that may be obtained from Rigaku Corporation, for example. Here, the electrode active material that is mainly an amorphous metal-phosphate complex refers to electrode active material having enough portions that are amorphous to on the whole be regarded as having the amorphous characteristics of (1) to (3) above even if there are crystalline portions in the electrode active material.

The method of manufacturing the foregoing electrode active material is not particularly limited as long as the electrode active material described is able to be obtained. For example, the electrode active material of the invention may be manufactured according to an amorphising process that rapidly cools a melt having a LiₓFeP_{y}O_{z} composition.

This amorphising process will now be described. The amorphising process is a process for obtaining an amorphous iron-phosphate complex by rapidly cooling a melt having a LiₓFeP_{y}O_{z} composition.

The method for rapidly cooling the melt used in this process (i.e., the melt rapid cooling method) is a method for amorphising a metal complex by rapidly solidifying the metal complex from a molten state. For example, a metal complex in a molten state is rapidly solidified by being put into a low temperature medium (such as ice water) so that it solidifies rapidly. More specifically, the single-roll method for rapidly cooling melt may be used, for example. This amorphising method may be repeated two or more times as necessary.

Normally in order to have the amorphous iron-phosphate complex contain Fe having a valence of 2, this process is preferably performed in a non-oxidizing atmosphere such as an inert gas atmosphere of, for example, argon gas or nitrogen (N₂), or an atmosphere that includes a reducing gas such as hydrogen gas. Of these, an inert gas atmosphere of argon gas is preferable.

The melt rapid cooling method includes a step of rapidly solidifying from a molten state a mixture including Li raw material (such as a Li compound), Fe raw material (such as an Fe oxide), and P raw material (such as a phosphate compound), which corresponds to the LiₓFeP_{y}O_{z}. This method may preferably be applied to a lithium iron-phosphate complex or the like.

The Li raw material used in this step may be one or two or more kinds of Li compounds. The Li compound may be, for example, Li₂O, LiOH, or Li₂CO₃. Of these, Li₂O is preferable. Using this kind of lithium compound enables electrode active material corresponding to a state in which lithium has been absorbed beforehand to be obtained. As a result, the irreversible capacity can be reduced. In addition, the melting point of the mixture can be reduced by selecting a lithium compound that can function as a flux of fusing agent which makes it easier to fuse the materials.

Also, the Fe raw material used in this step may be one or two or more kinds of Fe oxides. The Fe oxide may be, for example, FeO or Fe₂O₃ or the like, FeO being the more preferable.

Also, the P raw material used in this step may be one or two or more kinds of phosphorous compounds. The phosphorous compound may be, for example, phosphorous oxide or phosphorous ammonium salt or the like, P₂O₅ being preferable.

The average particle diameter and particle diameter distribution and the like of the raw materials used in this step are not particularly limited. Also, generally the raw materials are preferably relatively uniformly mixed, and more preferably almost uniformly mixed. However, the raw material composition is melted once so even if it is not that uniform, it is still possible to manufacture electrode active material with sufficient uniformity for practical use. In this way, the method used in this example embodiment differs from the solid reaction method of the related art in that it suppresses the effects of the nature and uniformity of the raw material composition on the product material and the manufacturing conditions are easy to control.

The electrode active material according to this example embodiment of the invention may be used, for example, as positive electrode active material of a high voltage nonaqueous electrolyte secondary battery which will now be described in detail.

The nonaqueous electrolyte secondary battery is a nonaqueous electrolyte secondary battery that has a positive electrode containing the electrode active material, a negative electrode containing negative electrode active material, and a nonaqueous electrolyte. The nonaqueous electrolyte secondary battery is advantageous in that it can have greater capacity even when used with a high potential. Hereinafter, the reason why the nonaqueous electrolyte secondary battery has this kind of advantage will be described. The nonaqueous electrolyte secondary battery is able to realize greater capacity by using the electrode active material described above as the positive electrode active material. That is, using the foregoing electrode active material having a composition range that not only facilitates the dispersion of Li but also facilitates the movement of electrons, both of which are necessary to improve the capacity, as positive electrode active material improves the specific capacitance such that a nonaqueous electrolyte secondary battery can be obtained which has superior charging and discharging characteristics in which greater capacity is possible even when used with a high potential. Hereinafter, the nonaqueous electrolyte secondary battery according to the example embodiment of this invention will be described in detail for each structure.

First, the positive electrode used in the high voltage nonaqueous electrolyte, secondary battery will be described. This positive electrode at least has the electrode active material described above and also normally has a binder to hold the electrode active material.

Any well-known binder may be used. More specifically, the binder may be, for example, polyvinylidene-fluoride (PVDF), polytetrafluoroethylene (PTFE), polyvinylidene-fluoride-hexafluoropropylene copolymer (PVDF-HFP), a fluorine-containing resin such as fluoro-rubber, or a thermoplastic resin such as polypropylene or polyethylene. Also, the content of the binder of the positive electrode layer is, for example, within a range of 1 to 10 percent by mass, and preferably within a range of 3 to 7 percent by mass.

Also, the positive electrode may contain an additive in addition to the positive electrode active material and the binder. A conductive agent, for example, may be used as the additive. More specifically, carbon black, acetylene black, ketjen black, or black lead or the like may be used as the conductive agent.

Next, the negative electrode used in the high voltage nonaqueous electrolyte secondary battery will be described. When the foregoing electrode active material is used as the positive electrode of the battery, a metal such as lithium (Li), natrium (Na), magnesium (Mg), aluminum (Al), or an alloy thereof, or carbon material that can absorb and release cations, or the like may be used as negative electrode active material for the counter electrode to the positive electrode. Furthermore, the negative electrode also normally has a binder to hold the negative electrode active material.

Examples of the binder include polyvinylidene-fluoride (PVDF) and styrene-butadiene rubber polymer (SBR), polyvinylidene-fluoride (PVDF) being the more preferable.

Further, the negative electrode may also contain an additive in addition to the negative electrode active material and the binder. A conductive agent, for example, may be used as the additive. More specifically, carbon black, acetylene black, ketjen black, or black lead or the like may be used as the conductive agent.

The nonaqueous electrolyte used in the high voltage nonaqueous electrolyte secondary battery may include a nonaqueous solvent and a compound (support electrolyte) that contains cations that can be inserted into and removed from electrode active material. The nonaqueous solvent of the nonaqueous electrolyte may be any of a variety of types of aprotic solvents such as a carbonate, ester, ether, nitrile, sulfone, or lactone type. Examples include propylene carbonate; ethylene carbonate; diethyl carbonate; dimethyl carbonate; ethyl methyl carbonate; 1,2-dimethoxyethane; 1,2-diethoxyethane; acetonitrile; propionitrile; tetrahydrofuran; 2-methyltetrahydrofuran; dioxane; 1,3-dioxolan; nitromethane; N,N-dimethylformamide; dimethylsulfoxide; sulfolane; and γ-butyrolactone. Only one type or a mixture of two or more types of nonaqueous solvent selected from among these kinds of nonaqueous solvents may be used. Also, a compound that includes cations that are inserted into/removed from the electrode active material may be used as the support electrolyte that constitutes the nonaqueous electrolyte. For example, with a lithium-ion secondary battery, one or two or more types of lithium compounds (lithium salts) such as LiPF₆, LiBP₄, LiN(CF₃SO₂)₂, LiCF₃SO₃, LiC₄F₉SO₃, LiC(CF₃SO₂)₃, and LiClO₄ may be used.

The nonaqueous electrolyte secondary battery may be any of a variety of shapes. For example, it may be coin-shaped, laminated (stacked), or cylindrical.

Also, the nonaqueous electrolyte secondary battery can be used with high voltage, the range of the maximum voltage being, for example, within 1.5 to 5 V, preferably within 2 to 4.75 V, and more preferably within 2.5 to 4.5 V.

The purpose for which the nonaqueous electrolyte secondary battery is used is not particularly limited. For example, the nonaqueous electrolyte secondary battery may be used in an automobile.

Incidentally, the invention is not limited to the foregoing example embodiment. The foregoing example embodiment simply illustrates an example. Other examples having substantially the same structure as the technical ideas described within the scope of the claims for patent of the invention and displaying the same operation and effects are also included within the technical scope of the invention.

Hereinafter, the invention will be described in even more detail with the following examples.

### EXAMPLE 1

Li₂O as the Li raw material, FeO as the Fe raw material, and P₂O₅ as the P raw material were mixed together at a molar ratio of Li:Fe:P=2.25:1:1.9 (Li/Fe=2.25 and P/Fe=1.9). This mixture was then melted for 1 minute at 1200° C. in an Ar atmosphere and then rapidly cooled with a Cu roll using a single-roll rapid cooling apparatus to obtain electrode active material represented by LiₓFeP_{y}O_{z} (where x=2.25 and y=1.9).

### EXAMPLE 2

Electrode active material was prepared as it was in Example 1 described above except for that the molar ratio of Li:Fe:P was 2.5:1:1.9 (Li/Fe=2.5 and P/Fe=1.9), such that electrode active material represented by LiₓFeP_{y}O_{z} (where x=2.5 and y=1.9) was obtained.

### COMPARATIVE EXAMPLE 1

Electrode active material was prepared as it was in Example 1 described above except for that the molar ratio of Li:Fe:P was 1.5:1:1.9 (Li/Fe=1.5 and P/Fe=1.9), such that electrode active material represented by LiₓFeP_{y}O_{z} (where x=1.5 and y=1.9) was obtained.

### COMPARATIVE EXAMPLE 2

Electrode active material was prepared as it was in Example 1 described above except for that the molar ratio of Li:Fe:P was 2:1:1.9 (Li/Fe=2 and P/Fe=1.9), such that electrode active material represented by LiₓFeP_{y}O_{z} (where x=2 and y=1.9) was obtained.

### EXAMPLE 3

Electrode active material was prepared as it was in Example 1 described above except for that the molar ratio of Li:Fe:P was 2.05:1:2 (Li/Fe=2.05 and P/Fe=2), such that electrode active material represented by LiₓFeP_{y}O_{z} (where x=2.05 and y=2) was obtained.

### EXAMPLE 4

Electrode active material was prepared as it was in Example 1 described above except for that the molar ratio of Li:Fe:P was 2.05:1:1.5 (Li/Fe=2.05 and P/Fe=1.5), such that electrode active material represented by LiₓFeP_{y}O_{z} (where x=2.05 and y=1.5) was obtained.

### COMPARATIVE EXAMPLE 3

Electrode active material was prepared as it was in Example 1 described above except for that the molar ratio of Li:Fe:P was 2.05:1:3 (Li/Fe=2.05 and P/Fe=3), such that electrode active material represented by LiₓFeP_{y}O_{z} (where x=2.05 and y=3) was obtained.

### COMPARATIVE EXAMPLE 4

Electrode active material was prepared as it was in Example 1 described above except for that the molar ratio of Li:Fe:P was 2.05:1:2.5 (Li/Fe=2.05 and P/Fe=2.5), such that electrode active material represented by LiₓFeP_{y}O_{z} (where x=2.05 and y=2.5) was obtained.

Next, the crystallinity of the electrode active materials represented by LiₓFeP_{y}O_{z} obtained from Examples 1 to 4 and Comparative examples 1 to 4 were evaluated by X-ray diffraction under the following conditions: Apparatus used: Rigaku, RAD-X; X-ray: CuKα, 40 kV, 40 mA; scan range: 2 θ=10° to 80°. After evaluating the electrode active materials obtained from Examples 1 to 4 and Comparative examples 1 to 4 using X-ray diffraction, only X-ray diffuse scattering specific to amorphous material could be seen in all of the electrode active materials. Therefore all of the obtained electrode active materials were confirmed to be amorphous, no crystalline material was confirmed. Incidentally, amorphising was not possible when Li/Fe (molar ratio) was greater than 2.5 and the P/Fe (molar ratio) was less than 1.5. The range in which amorphising was possible was Li/Fe (molar ratio)≦2.5 and P/Fe (molar ratio)≦1.5.

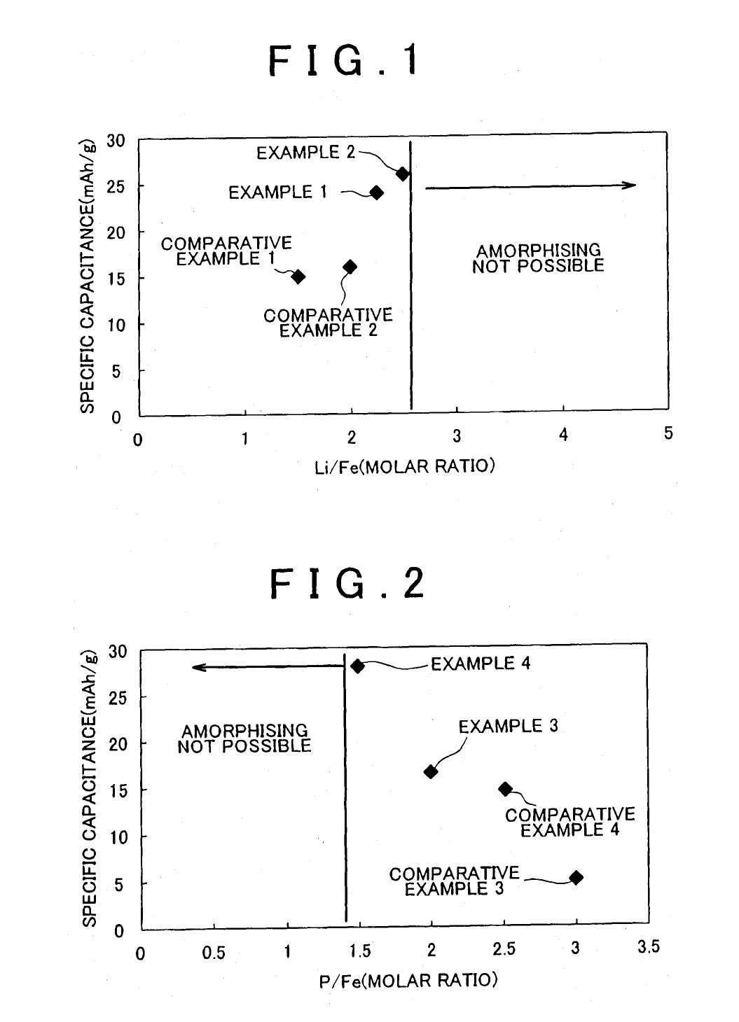

Test cells were manufactured using the foregoing electrode active materials represented by LiₓFeP_{y}O_{z} that were obtained by Examples 1 to 4 and Comparative examples 1 to 4, and the charging and discharging characteristics of each were evaluated. That is, a sample of the electrode active material as the electrode active material, acetylene black as the conductive agent, and polytetrafluoroethylene (PTFE) as the binder were mixed together such that the mass ratio of electrode active material to conductive agent to binder was 70:25:5 (percent by mass). A test electrode was then manufactured by pressing this mixture onto SUS (stainless steel) mesh so that it was affixed thereto. Metal Li was used as the counter electrode and a polyethylene (PE) separator (Ube Industries, Ltd.) was used for the separator. Also, for the electrolyte solution, a mixture was used in which lithium hexafluorophosphate (LiPF₆) as a supporting salt was mixed at a concentration of 1 mol/L in with a mixed solvent with a volume ratio of 3:7 of ethylene carbonate (EC) and diethyl carbonate (DEC). The test coin cells were manufactured using these constituent elements. Charging and discharging with a current value of 0.1 (mA/cm²) within a voltage range of 2.5 to 4.5 V was then performed with these test cells and the specific capacitance of each was measured. The specific capacitances of Examples 1 and 2 and Comparative examples 1 and 2 having compositions in which P/Fe (molar ratio) was fixed at 1.9 and Li/Fe (molar ratio) was changed in the General expression LiₓFeP_{y}O_{z} are shown in FIG. 1. The specific capacitances of Examples 3 and 4 and Comparative examples 3 and 4 having compositions in which P/Fe (molar ratio) was fixed at 2.05 and Li/Fe (molar ratio) was changed in the General expression LiₓFeP_{y}O_{z} are shown in FIG. 2.

As shown in FIG. 1, in Examples 1 and 2 in which the value of Li/Fe (molar ratio) is greater than 2, the specific capacitances were 24 (mAh/g) and 26 (mAh/g), respectively. These are larger than the specific capacitances in Comparative examples 1 and 2, in which the value of Li/Fe (molar ratio) is equal to or less than 2, which were 15 (mAh/g) and 16 (mAh/g), respectively.

Also, as shown in FIG. 2, in Examples 3 and 4 in which the value of P/Fe (molar ratio) is equal to or less than 2, the specific capacitances were 16 (mAh/g) and 28 (mAh/g), respectively. These are larger than the specific capacitances in Comparative examples 3 and 4, in which the value of P/Fe (molar ratio) is greater than 2, which were 4 (mAh/g) and 14 (mAh/g), respectively.

As is evident from these results, high capacity amorphous electrode active material was able to be obtained by having the range of the relative proportions of x(=Li/Fe (molar ratio)) and y(=P/Fe (molar ratio)) in the iron-phosphate complex represented by LiₓFeP_{y}O_{z} be within 2<x≦2.5 and 1.5≦y≦2, respectively.

1. Electrode active material which is represented by LiₓFeP_{y}O_{z} and comprises an amorphous iron-phosphate complex as a main constituent, wherein x and y are values which independently satisfy 2<x≦2.5 and 1.5≦y≦2, respectively; z=(x+5y+valence of iron)/2 to satisfy stoichiometry; and the valence of the iron is 2 or 3.

2. A manufacturing method for electrode active material, comprising:
melt mixing raw material composition that includes raw materials that make up LiₓFeP_{y}O_{z} (where x and y are values which independently satisfy 2<x≦2.5 and 1.5≦y≦2, respectively, z=(x+5y+valence of iron)/2 to satisfy stoichiometry, and the valence of iron is 2 or 3); and
rapidly solidifying from a molten state the raw material composition that was melt mixed.

3. A lithium-ion secondary battery comprising:
a positive electrode layer that includes the electrode active material according to claim 1 as positive electrode active material;
a negative electrode layer that includes negative electrode active material; and
a nonaqueous electrolyte.
